(19) United States
(12) Patent Application Publication
(10) Pub. No.: US 2005/0000274 A1
(43) Pub. Date: Jan. 6, 2005

(54) Method and device for analyzing the hardening of hardenable formulations

(76) Inventors: Wolfgang Schrof, Neuleiningen (DE); Thorsten Muller, Mettenheim (DE); Sebastian Koltzenburg, Dannstadt-Schauernheim (DE); Matthias Kroner, Eisenberg (DE); Stephan Lehmann, Ludwigshafen (DE); Joachim Hadeler, Frankenthal (DE)

Correspondence Address: KEIL & WEINKAUF, 1350 CONNECTICUT AVENUE, N.W., WASHINGTON, DC, 20036, US

(21) Appl. No.: 10/491,423

(22) PCT Filed: Sep. 27, 2002
(86) PCT No.: PCT/EP02/10910

(30) Foreign Application Priority Data
Oct. 1, 2001 (DE) 101 48 567.0

(51) Int. Cl. G01N 3/48

(52) U.S. Cl. 73/81

(57) ABSTRACT

The invention relates to a process for the combinatorial investigation of the hardening of hardenable liquid or viscous formulations (a) in which n hardenable formulations are prepared in parallel in n containers, and (b) the degree of hardening is determined at least once on each of the n formulations by inserting a measurement tip into the formulation with a certain force and measuring the maximum penetration depth achieved as a measure of the degree of hardening of this formulation, and (c) for in each case one composition of the formulations, one or more parameters that are characteristic of the kinetics of hardening are determined from the measurement values for the penetration depth at various times after preparation of the formulations. Steps (a) to (c) are preferably carried out a number of times, and a dependence of the characteristic parameter(s) on the composition of the formulations is determined by analysis of the large number of individual values obtained in this way for the parameter(s) that is (are) characteristic of the kinetics of hardening, enabling the composition of the formulations to be optimized with respect to its hardening behavior.

The invention relates to a process for the combinatorial investigation of the hardening of n hardenable liquid or viscous formulations and to a process for investigating the hardening of individual hardenable liquid or viscous formulations.

In combinatorial materials research, a large number of new materials are produced in a short time on a small scale and tested for important material properties. By evaluating a large number of measurement results on different formulations, lead structures and structure-activity relationships are identified in so-called combinatorial process loops. These lead structures are subsequently developed to the commercial product by classical optimization in development engineering.

Combinatorial materials research today relates to a multiplicity of systems of widely varying types. Examples are novel catalysts, novel structural and functional polymers or improved formulations for a multiplicity of applications. Besides parallel preparation and rapid characterization of the formulations, efficient data management is a prerequisite for success of combinatorial material research. This includes automated planning of experiments, computer-supported performance thereof by control of synthesis robots and measuring instruments, the archiving and visualization of large amounts of data and the analysis of these data in order to find structure-activity relationships.

In order to delay the hardening of concrete mixtures, certain polymers are added to the latter as additives. In order to test the plasticizer action of additives in concrete, a spread test is carried out in accordance with DIN 1048, in which the viscosity of the concrete formulation is determined from the flow of a shaped sample of the formulation on a substrate. This test requires complex manual work. For example, the individual formulations have to be prepared manually by weighing out the individual components, mixed, transferred into a mold and applied to a substrate by inverting the mold. The diameter of the formulation that has flowed out on the substrate has to be measured manually after a certain time. If it is intended to determine the kinetics of concrete hardening, a number of such tests have to be carried out with the same concrete formulation, which means considerable effort. Since the hardening times for concrete mixtures can be up to 24 hours, series experiments in accordance with this standard test method are time-consuming and labor-intensive. A single test requires a large amount of material (about 500 g). Small amounts of polymer, as obtained from combinatorial syntheses, are inadequate for this standard test.

It is an object of the present invention to provide a simple and fast method for investigating the hardening of concrete mixtures which can be employed in combinatorial material research.

We have found that this object is achieved by a process for the combinatorial investigation of the hardening of hardenable liquid or viscous formulations
(a) in which n samples of hardenable formulations are prepared in parallel in n containers, and
(b) the degree of hardening is determined at least once on each of the n samples by inserting a measurement tip into the sample with a certain force and measuring the maximum penetration depth achieved as a measure of the degree of hardening of this sample, and
(c) for in each case one composition of the formulations, one or more parameters that are characteristic of the kinetics of hardening are determined from the measurement values for the penetration depth at various times after preparation of the formulations.

In the process according to the invention, n hardenable liquid or viscous formulations are prepared in parallel. Suitable containers are, for example, the wells of a microtitre plate. The formulations can be prepared automatically or manually. For automatic preparation of the formulations, use can be made, for example, of an automatic pipette, which dispenses the individual components of the formulations into the container in the desired amounts.

The number n of samples prepared in parallel is at least 2 and can in principle be as large as desired. It is usually from 2 to 1000, preferably from 10 to 1000.

The degree of hardening is determined at least once on each of the n formulations. To this end, a measurement tip is inserted into the formulation with a certain force. The force which the measurement tip exerts on the sample is usually selected in such a way that the tip penetrates the sample to the container base when the sample is in the incompletely hardened state, while it no longer penetrates into the sample in the fully hardened state of the latter. The measurement tip can be made of any desired material. The measurement tip preferably has a shape which only partially penetrates into the sample in the case of partial hardening of the sample. In a particularly preferred embodiment of the process according to the invention, the measurement tip is furthermore of such a diameter that a plurality of individual measurements can be carried out on the same sample without influencing one another. This also enables (highly viscous) intermediate states of the hardening process to be detected. As a measure of the degree of hardening, the penetration depth of the measurement tip is measured. This is at a maximum in the liquid or comparatively low-viscosity state of the sample and a minimum (in the ideal case equal to zero) in the completely hardened state of the sample, and can adopt values lying between these extremes for more or less highly viscous intermediate states of the sample. The terms “low-viscosity” and “high-viscosity” in this connection are not absolute terms, but instead are to be understood to be relative to the force exerted by the tip.

The penetration depth is measured for each composition of the formulations at different times after preparation of the formulations. The measurements of the penetration depth at different times can be carried out on different samples of the same composition. In order to increase the sample throughput, however, it is preferred to carry out a number of measurements at different times on a plurality of spatially separated points on the same sample. The number of insertion points per sample depends on the diameter of the sample containers and the diameter of the measurement tip and can be, for example, between 2 and 20. In the case of a standard microtitre plate having 48 wells (diameter of a well about 1 cm), it can be, for example, 7. The maximum sample throughput is achieved by each sample having a different composition from all the other samples. In order to determine the measurement accuracy, it may be appropriate to carry out a plurality of individual measurements at essentially the same time on a plurality of samples of the same composition.

For each composition, one or more parameters that are characteristic of the kinetics of hardening are determined from the measurement values for the penetration depth at various times after preparation of the samples. A suitable kinetic parameter is the time that has passed from preparation of the samples until the measured penetration depth has dropped to, for example, half the maximum value.

The penetration depth is measured automatically, preferably by means of a displacement transducer, and under computer control. The measured penetration depths are acquired and evaluated by a computer.

The hardenable formulations can be any desired systems. For example, two-component adhesives or two-component paint systems whose curing behavior is to be investigated as a function of the composition.

In the case of adhesive or adhering formulations, the measurement tip is preferably cleaned automatically after each individual measurement by washing, brushing and drying. To this end, for example, the measurement tip can be immersed in a washing liquid and subsequently moved along a brush.

Instead of a displacement transducer, a force transducer can be employed as an alternative, and instead of the maximum penetration depth of the measurement tip into the sample, the force exerted on the measurement tip during penetration of the measurement tip into the sample can be measured. This process variant is otherwise entirely analogous to the variant described above. Corresponding kinetic parameters for the hardening of the formulations can be determined from these measurement values for this measurement quantity referred to as penetration force at various times after preparation of the samples. A suitable kinetic parameter in this variant is the time that has passed from preparation of the samples until a certain penetration force has been reached.

A preferred area of application of the process according to the invention is the investigation of the hardening behavior of cement formulations which comprise polymers having a concrete-plasticizing action. A measure of the activity of a concrete-plasticizing polymer is the hardening time of the cement formulation, which can be defined as the time after preparation of the cement formulation after which the penetration depth has dropped to half the original value. By fitting, for example, a Boltzmann function to the measurement values, this value can also be determined from a comparatively small number of individual values for the penetration depth, for example 7 individual values for each sample.

In order to obtain hardening-characteristic parameters for the highest possible number of different formulations, the process according to the invention is preferably repeated a number of times, with the composition of the formulations being varied systematically. By analysis of the large number of individual values obtained in this way for the characteristic parameter(s) for the kinetics of hardening, a systematic dependence of the characteristic parameter(s) on the composition of the formulations can be determined, enabling the composition of the formulations to be optimized with respect to its hardening behavior.

In order to determine structure-activity relationships for the concrete-plasticizing action of polymers, the cement formulations can be varied systematically from a multiplicity of points of view. Examples are the type and mixing ratio of the monomers present in the polymers, polymer architecture (use of block copolymers, graft copolymers, random copolymers, alternating copolymers, multiblock copolymers), degree of branching, tacticity (isotactic, syndiotactic, atactic), molecular weight, molecular weight distribution, charge state (cationic, anionic, nonionic), concentration of the polymers in the cement mixture and type of cement employed.

The invention also relates to an apparatus for the combinatorial investigation of the hardening of hardenable liquid or viscous formulations, comprising
(i) n containers for the parallel preparation of n samples,
(ii) an automatic positioner with lowerable robot arm,
(iii) a measurement tip connected to the robot arm,
(iv) an automatic displacement transducer connected to the measurement tip for measuring the penetration depth of the measurement tip lowered into the sample,
(v) an automatic control, data acquisition and data evaluation system for control of the positioner and the robot arm and acquisition and storage of the penetration depth measured by the displacement transducer.

The process according to the invention uses a particularly simple and rapid method for determining the hardening time of cement formulations. This determination method can readily also be employed in the case of only one sample. The present invention therefore also relates to a process for investigating the hardening of a liquid or viscous hardenable formulation, in particular a cement formulation,
(a) in which a sample of the hardenable liquid or viscous formulations is prepared in a container, and
(b) the degree of hardening of the samples is determined a number of times on the sample by inserting a measurement tip into the sample repeatedly and at different times with a certain force at spatially separated points and measuring the maximum penetration depth achieved as a measure of the degree of hardening of this sample, and
(c) determining one or more parameters that are characteristic of the kinetics of hardening for the formulation from the measurement values for the penetration depth at various times after preparation of the formulation.

The present invention also relates to an apparatus for investigating the hardening of a liquid or viscous hardenable formulation, in particular a cement formulation, comprising
(i) a container for preparation of a sample,
(ii) an automatic positioner with lowerable robot arm,
(iii) a measurement tip connected to the robot arm,
(iv) an automatic displacement transducer connected to the measurement tip for measuring the penetration depth of the measurement tip lowered into the sample,
(v) an automatic control, data acquisition and data evaluation system for control of the positioner and the robot arm and for the acquisition and storage of the penetration depth measured by the displacement transducer.

The invention is explained in greater detail with reference to the drawing.

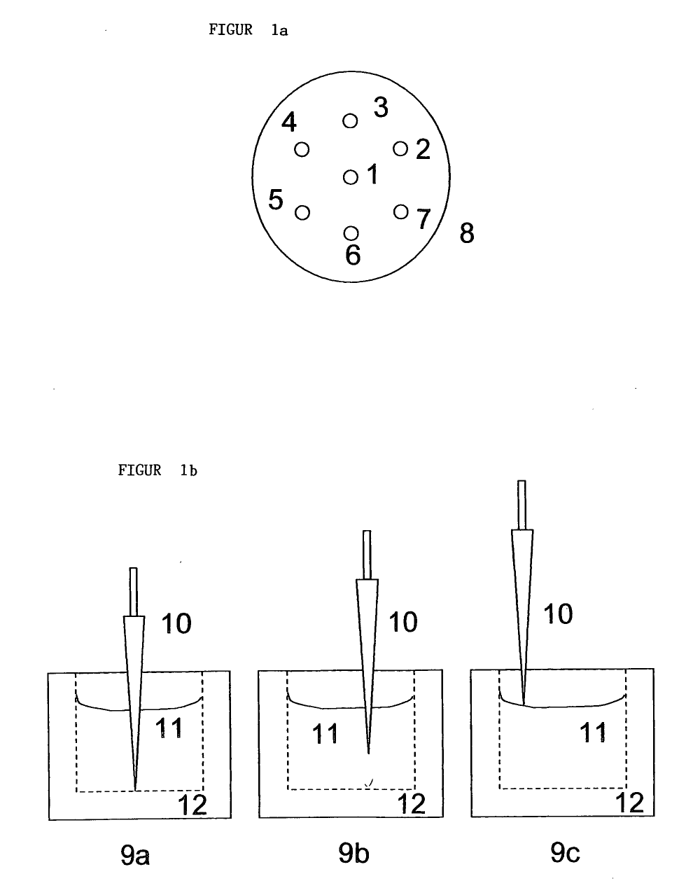

FIG. 1a shows a plan view of an individual sample, the whole of which is denoted by 8, with insertion points 1 to 7 which follow one another in time sequence.

FIG. 1b shows sections through a well 12 of a microtitre plate with an individual sample 11 with various penetration depths of the tip 10 during various phases of hardening 9a (low viscosity), 9b (high viscosity) and 9c (fully hardened).

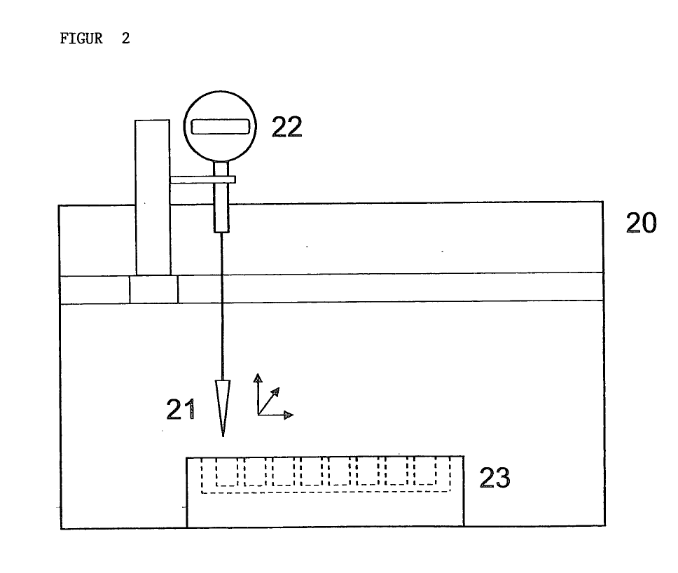

FIG. 2 shows a side view of an apparatus for carrying out the process according to the invention with a mechanical positioner 20. The positioner moves the desired well of a multisample carrier 23 into position and lowers the measurement tip 21 into the well containing the sample. A dial gauge 22 with displacement transducer measures the penetration depth of the measurement tip. The measured penetration depth is automatically transferred to a computer, stored and evaluated.

1. A process for the combinatorial investigation of the hardening of hardenable liquid or viscous formulations
(a) in which n hardenable formulations are prepared in parallel in n containers, and
(b) the degree of hardening is determined at least once on each of the n formulations by inserting a measurement tip into the formulation with a certain force and measuring the maximum penetration depth achieved as a measure of the degree of hardening of this formulation, and
(c) for in each case one composition of the formulations, one or more parameters that are characteristic of the kinetics of hardening are determined from the measurement values for the penetration depth at various times after preparation of the formulations, and
(d) by analysis of the large number of individual values obtained in this way for the parameter(s) that is (are) characteristic of the kinetics of hardening, a dependence of the characteristic parameter(s) on the composition of the formulations is determined, enabling the compositions of the formulations to be optimized with respect to its hardening behavior.

2. A process as claimed in claim 1, wherein the n hardenable formulations are cement formulations comprising polymers having a concrete-plasticizing action.

3. A process as claimed in claim 1, wherein the penetration depth is measured on each of the n formulations at a plurality of different times after preparation of the respective formulation.

4. A process as claimed in claim 3, wherein the penetration depth is determined at a plurality of spatially separated insertion points of the respective formulation.

5. A process as claimed in claim 1, wherein each of the n formulations has a different composition from all the other formulations.

6. A process as claimed in claim 1, wherein the parameter that is characteristic of the kinetics of hardening is the time that has passed from preparation of the formulation until a certain maximum penetration depth has been reached.

7. A process as claimed in claim 1, where the number n of formulations prepared in parallel is from 2 to 1000.
